(19) United States
(12) Patent Application Publication
(10) Pub. No.: US 2002/0110307 A1
(43) Pub. Date: Aug. 15, 2002

(54) Optical polarization beam splitter/combiner with isolation in the backward optical path

(76) Inventors: Yonglin Huang, Milpitas, CA (US); Qi Deng, Cupertino, CA (US); Liren Du, Mountain View, CA (US)

Correspondence Address: B. Noel Kivlin, Conley, Rose, & Tayon, P.C., P.O. Box 398, Austin, TX, 78767, US

(21) Appl. No.: 10/075,333

(22) Filed: Feb. 14, 2002

Related U.S. Application Data
(60) Provisional application No. 60/269,224, filed on Feb. 14, 2001.

(51) Int. Cl. G02B 6/00; G02B 6/26

(52) U.S. Cl. 385/11; 385/50

(57) ABSTRACT

An optical device is described that may be used to split a beam of light into two or more components of light or combine two or more components of light into a combined beam of light. The optical device may also provide isolation (i.e., inhibit optical feedback) in the reverse direction. The beam of light may be split into two or more polarized components of light. Similarly, the two or more components of light that are combined may be polarized. The optical device may be coupled to optical fibers for both input and output of the beam of light or the two or more components of light.

### PRIORITY CLAIM

This application claims priority to U.S. Provisional Patent Application No. 60/269,224 entitled “Optical Polarization Beam Splitter/Combiner with Isolation in the Backward Optical Path” filed on Feb. 14, 2001.

### BACKGROUND OF THE INVENTION

1. Field of the Invention

The present invention relates to an optical beam splitting/combining device that includes isolation in a reverse direction. The optical beam splitting/combining device may be used over a broad wavelength in an optical network or multiplexing system.

2. Description of the Related Art

The telecommunications network serving the United States and the rest of the world is presently evolving from analog to digital transmission with ever increasing bandwidth requirements. Optical fiber has proved to be a valuable tool, replacing copper cable in nearly every application from large cable trunks to subscriber distribution plants. Optical fiber is capable of carrying much more information than copper with lower attenuation.

Currently expansion of bandwidth in fiber optic networks is being accomplished by what is known as “wavelength division multiplexing” (WDM), in which modulation techniques are used to handle separate subscriber/data sessions concurrently on a single optical fiber. Current International Telecommunications Union (ITU) specifications call for channel separations of approximately 50 GHz. The ITU grid typically refers to those frequencies centered about approximately 1550 nm (e.g., approximately 1525 nm to 1575 nm for the C band). At those wavelengths, 50 GHz channel spacing corresponds to a wavelength separation of approximately 0.4 nm. In WDM applications, each subscriber datastream is optically modulated onto the output beam of a corresponding laser. The modulated information from each of the semiconductor lasers is then combined onto a single optical fiber for transmission.

WDM networks are evolving towards re-configurable architectures in which each transmitter's (or laser's) wavelength must be re-selectable on command. Re-configurable networks offer significant capacity, reliability, and management advantages over static systems (See, e.g., R. Ramaswami and K. Sivarajan, Optical Networks, A Practical Perspective, Morgan Kaufmann Publishers, 1998).

Across an optical network, a broad range of optical devices (e.g., transmitters, receivers, multiplexers, demultiplexers, amplifiers, splitters, combiners, isolators, etc.) must be fabricated to handle each of these channels or wavelengths. Typically, each device is fabricated for a specific or narrow channel.

Thus having devices in an optical network that are operable over a wide range of wavelengths increases the ability of the devices to operate for a wide range of lasers. This reduces inventory costs because the number of separate wavelength devices needed for the optical network decreases as each device's wavelength range increases. Also, combining the functions of two or more devices into a single device can save space within the optical network and reduce transmission losses within the optical network. Reducing transmission losses in the optical network can reduce the number of lasers needed and/or reduce the power consumption of the lasers. Providing optical devices that combine the features of two or more discrete wavelength optical devices and that operate over a wide range of wavelengths results in significant cost reductions compared to using discrete, narrow wavelength optical devices.

### SUMMARY OF THE INVENTION

In an embodiment, a single optical device may be used to split a beam of light into two or more components of light and/or combine two or more components of light into a combined beam of light as well as providing isolation in a reverse direction (i.e., inhibit optical feedback). The optical device may include a first fiber coupling coupled to a fiber. The fiber may be used to propagate the beam of light or the combined beam of light. The beam of light may be collimated or focused by a lens placed in the first fiber coupling. In another embodiment, the beam of light is collimated or focused by a lens shaped fiber tip placed in the first fiber coupling. The beam of light may be split into two or more components of light by a beam splitter/combiner placed in the path of the beam of light in the optical device.

In another embodiment, two or more components of light may be combined into a combined beam of light by the beam splitter/combiner of the optical device. The optical device may include a second fiber coupling coupled to two or more additional fibers or lens shaped fiber tips. The two or more components of light may be collimated or focused by one or more lenses placed in the second fiber coupling. The two or more additional fibers may be used to propagate the two or more components of light. The optical device may include an isolator placed in the path of the beam of light. The isolator may be used to inhibit optical feedback in a reverse direction within the optical device.

In certain embodiments, the isolator includes a Faraday rotator, an input wedge, and an output wedge. The isolator may be positioned to inhibit optical feedback in a desired direction. For example, the isolator may be positioned to inhibit optical feedback towards the first fiber coupling when the optical device is used to split a beam of light. Alternately, the isolator may be positioned to inhibit optical feedback towards the second fiber coupling when the optical device is used to combine two or more components of light.

In an embodiment, the beam splitter/combiner includes a prism. The prism may split a beam of light into two polarized components of light at a diverging angle. In another embodiment, the prism may combine polarized components of light into a combined beam of light. The diverging angle of the prism may substantially match the diverging angle of the components of light coming from or entering the one or more lenses in the second fiber coupling. Matching the diverging angles may reduce transmission losses within the optical device.

The optical device may be used as a passive device included in, for example, an optical network. The optical device may be used as a splitter or combiner in an optical network. In some embodiments, the optical device may be used to split multiple sets of beams of light and/or combine multiple sets of components of light. The multiple sets of beams of light and multiple sets of components of light may be multiplexed within the optical device such that the sets do not intersect or interfere with each other.

An advantage of the described optical device may be an optical path free of contaminants (e.g., epoxy). Another advantage of the optical device may include the ability to operate at relatively high power densities, a relatively wide wavelength operating range, and a reduction in transmission losses compared to systems that include discrete splitting/combining devices and isolators. Furthermore, combining a splitting/combining function with an isolation function in a single device may reduce manufacturing, installation and/or operating costs associated with optical networks.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 depicts a schematic of an embodiment of an optical beam splitting/combining device;

FIG. 2 depicts a schematic of an embodiment of an isolator;

FIG. 3 depicts a schematic of an embodiment of a Wallaston prism;

FIG. 4 depicts a cross-sectional view of an embodiment of a ferrule containing two fibers; and

FIG. 5 depicts a schematic of an embodiment of an optical beam splitting/combining device placed in a housing.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

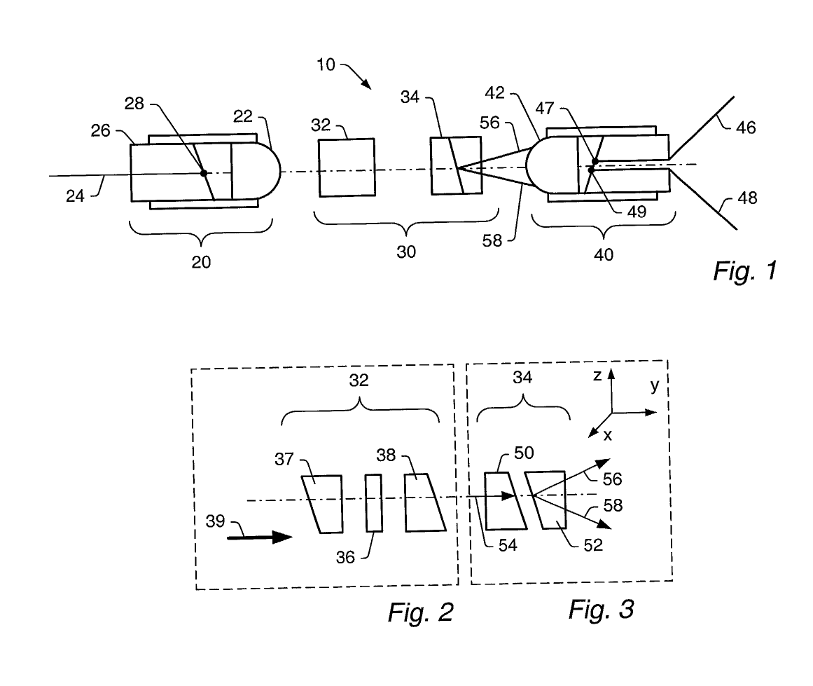

Turning to the drawings, FIG. 1 depicts a schematic of an embodiment of optical beam splitting/combining device 10. Optical beam splitting/combining device 10 may include first fiber coupling 20, core section 30, and second fiber coupling 40. In one embodiment (beam splitting embodiment), a beam of light enters first fiber coupling 20; the beam of light splits into two or more components of light in core section 30; and the two or more components of light exit through second fiber coupling 40. In another embodiment (beam combining embodiment), two or more components of light enter second fiber coupling 40; the two or more components of light combine into a beam of light in core section 30; and the beam of light exits through first fiber coupling 20.

First fiber coupling 20 may couple to fiber 24. First fiber coupling 20 may be a single fiber coupling. In some embodiments, first fiber coupling 20 may be coupled to more than one fiber. Fiber 24 may be a single mode fiber, a multimode fiber, or a polarization maintaining (PM) fiber. A single mode fiber may include a single optical transverse mode over a core cross section of the fiber. A multimode fiber may include more than one transverse mode over a core cross section of the fiber. In one embodiment, a single mode fiber may be used in a long distance optical communication application. A beam of light may propagate along the length of fiber 24. Fiber 24 may also include pigtail 26. Pigtail 26 may improve the strength and flexibility of fiber 24. End 28 of fiber 24 may be placed within first fiber coupling 20. A beam of light may exit or enter fiber 24 through end 28. End 28 may include an optically polished surface. The optically polished surface may be angled to an optical axis of the fiber. In some embodiments, an anti-reflection (AR) coating is applied to end 28 of fiber 24.

First fiber coupling 20 may include lens 22. Lens 22 may be a conventional spherical lens, a graded-index (GRIN) lens, or an aspherical lens. Lens 22 may collimate or focus a beam of light entering the lens. In one embodiment, lens 22 collimates a beam of light coming from fiber 24. In another embodiment, lens 22 focuses a beam of light into fiber 24. Lens 22 may be placed in an optimal position in relation to fiber 24 and isolator 32. The optimal position may be, for example, a position such that the focal point of lens 22 coincides with a position of end 28 of fiber 24. Positioning lens 22 optimally may minimize transmission loss between fiber 24, lens 22, and isolator 32.

In some embodiments with more than one fiber coupled to first fiber coupling 20, more than one lens may be used in the first fiber coupling. For example, one lens may be used to focus or collimate a beam of light associated with each fiber coupled to first fiber coupling 20. In other embodiments with more than one fiber coupled to first fiber coupling 20, one lens may be used to focus or collimate the beams of light associated with the more than one fiber.

Core section 30 may include isolator 32 and beam splitter/combiner 34. FIG. 2 depicts a schematic of an embodiment of isolator 32. Isolator 32 may be, for example, a Faraday isolator. A Faraday isolator 32 may include Faraday rotator 36, input wedge 37, and output wedge 38. Faraday rotator 36, input wedge 37, and output wedge 38 may be optically coupled. In an embodiment, a beam of light may travel through isolator 32 in a path indicated by arrow 39. Input wedge 37 may polarize the beam of light in a vertical plane (i.e., about 90° from the path of arrow 39). Faraday rotator 36 may rotate the polarized light in the vertical plane about 45°. A polarization plane of output wedge 38 may be aligned about 45° relative to the polarization plane of input wedge 37. Thus, the polarized light rotated about 45° by Faraday rotator 36 may pass through output wedge 38 relatively uninhibited.

Any light propagating in a reverse direction (a direction opposite of arrow 39) may first pass through output wedge 38. Output wedge 38 may polarize light passing in the reverse direction in the approximately 45° plane. The reverse direction light may be further rotated, in a non-reciprocal manner, approximately another 45° by Faraday rotator 36. The reverse direction light may now be polarized in a horizontal plane (i.e., 90° polarization from the vertical plane of input wedge 37). Light polarized in the horizontal plane may be rejected by input wedge 37, which has a vertical polarization plane. Thus, light from the reverse direction may not pass through isolator 32 (i.e., isolator 32 inhibits optical feedback through the isolator). In certain embodiments, isolator 32 may provide up to about 30 dB isolation of light traveling in the reverse direction. In other embodiments, isolator may provide up to 40 dB isolation or 50 dB isolation.

In one embodiment, isolator 32 may be arranged such that a beam of light propagates through the isolator (represented by arrow 39) from first fiber coupling 20 towards beam splitter/combiner 34 (beam splitting embodiment). In another embodiment, isolator 32 may be arranged such that a beam of light propagates through the isolator (represented by arrow 39) from beam splitter/combiner 34 towards first fiber coupling 20 (beam combining embodiment). In some embodiments, isolator 32 may be operable so that the isolator can be arranged in either direction (i.e., inhibit optical feedback towards either first fiber coupling 20 or beam splitter/combiner 34). For example, isolator 32 may be placed on a rotating base that rotates the isolator about a central axis approximately 180° so that the isolator can operate in either direction. The rotating base may be controlled by a user of the device (e.g., a turn knob outside the device coupled to the rotating base) or; in some embodiments, the rotating base may be automatically controlled and operated by a switch. In another embodiment, a direction of a magnetic field applied to Faraday rotator 36 may be switched to switch the isolation direction of the Faraday rotator and, thus, the isolation direction of isolator 32. The direction of the magnetic field may be switched mechanically and/or electrically. For example, a switch may be operated by a user to control the direction of the magnetic field. In some embodiments, the switch may be automatically controlled.

In another embodiment, isolator 32 includes a Faraday rotator, a polarizer, and a polarization analyzer. Isolator 32 may be a polarization dependent isolator. In some embodiments, the isolator may be positioned between the second fiber coupling and the beam splitter/combiner. Isolator 32 may separately isolate each component of light propagating through the isolator. The isolation direction of isolator 32 may be selected by selecting the magnetic field direction applied to the Faraday rotator.

In some embodiments, isolator 32 may provide isolation for more than one beam of light propagating through the isolator. In such embodiments, the more than one beam of light may have points of incidence on isolator 32 that are substantially offset so that the beams of light do not intersect or interfere with each other.

In one embodiment, beam splitter/combiner 34 is used to split a beam of light coming from first fiber coupling 20 into two components of light (a first component and a second component). The two components of light may be polarized in substantially different directions or planes. For example, the first component of light may be polarized approximately perpendicular relative to the polarization plane of the second component of light. In other embodiments, the first component may be polarized at a non-perpendicular angle relative to the polarization plane of the second component of light (e.g., approximately 45°, 60°, or 75°). Beam splitter/combiner 34 may include a prism or any similar device that splits a single beam into two or more component beams. Beam splitter/combiner 34 may also include a prism or similar device that splits and polarizes a single beam into two or more component beams. Beam splitter/combiner 34 may include birefringent materials. Examples of birefringent materials may include calcium carbonate (calcite), yttrium orthovanadate (YVO₄), titanium oxide (rutile), lithium niobate (LiNbO₃), and other crystalline materials. In certain embodiments, LiNbO₃, rutile, and YVO₄ may be desirable because of their high optical birefringence, low optical absorption loss, and their relatively good mechanical properties. Examples of prisms that may be used as beam splitter/combiner 34 include, but are not limited to, a thin film coated right angle prism (RAP), Wallaston prism, Nicol prism, and Rochon prism.

FIG. 3 depicts a schematic of an embodiment of a Wallaston prism that may be used as beam splitter/combiner 34. Beam splitter/combiner 34 may include wedge 50 and wedge 52. Wedge 50 and wedge 52 may be optically coupled. Wedge 50 and wedge 52 may have optical axes orthogonally crossed as compared to a direction of light propagation represented by arrow 54. Further, the optical axis (plane of polarization) of wedge 50 may be approximately 90° rotated from the optical axis of wedge 52. For example, as shown in FIG. 3, if a beam of light propagates in the y-direction, wedge 50 may have an optical axis in the x-direction while wedge 52 has an optical axis in the z-direction, or vice versa. Beam splitter/combiner 34 may split beam of light 54 into components of light 56, 58. In some embodiments, beam splitter/combiner 34 may split beam of light 54 into more than two components of light. In other embodiments with more than one beam of light 54 incident on beam splitter/combiner 34, multiple components of light in different planes may be split by the beam splitter/combiner. In such embodiments, each incident beam of light is split into two or more components that will have properties similar to components of light 56, 58 as described herein. Components of light 56, 58 tend to be polarized in approximately 90° planes according to the optical axes of wedges 50, 52. For example, the first component of light 56 may be polarized in the x-direction while the second component of light 58 is polarized in the z-direction.

Wedge 50 and wedge 52 may each have a cutting angle, θ, as shown in FIG. 3. The cutting angle may be used to determine the diverging angle, γ, of components 56, 58 based on the ordinary index of refraction (nₒ) and the extraordinary index of refraction (n_{ε}) of the birefringent material used in wedges 50, 52. The following equation may be used to determine the diverging angle, γ, for a Wallaston prism:

γ=2·arc Sin[(n₀−n_{ε})·tan θ]. EQN. (1)

As an example, if calcite (nₒ=1.66; n_{ε}=1.49) is used as the material for wedges 50, 52 which have a cutting angle, θ, of 25°, then the diverging angle, γ, according to EQN. 1, may be about 9.1°. If LiNbO₃ (nₒ=2.286; n_{ε}=2.2) is used in the wedges, the diverging angle, γ, may be about 4.6°. In a Wallaston prism, the diverging angle of components of light 56, 58 may be relatively balanced about the axis of input beam of light 54 (i.e., each component of light 56, 58 may have an angle diverging from the axis of the input beam which is approximately γ/2).

Alternate embodiments of beam splitters/combiners may also be used, which will have a different equation relating the diverging angle to the cutting angle. For example, using a Rochon prism as the beam splitter/combiner will generate a straight through beam, which is aligned on the input axis, and a diverging beam, which diverges from the input axis.

In some embodiments, beam splitter/combiner 34 may split more than one beam of light propagating through the beam splitter/combiner. In such embodiments, the more than one beam of light may have points of incidence on beam splitter/combiner 34 that are substantially offset so that the beams of light do not intersect or interfere with each other. In other embodiments, beam splitter/combiner 34 may combine multiple sets of component beams into multiple beams of light. As with the beam splitting embodiments, the multiple sets of component beams may have points (or planes) of incidence that are substantially offset so that the multiple sets of beams and the multiple combined beams do not intersect or interfere with each other.

As shown in FIG. 1, components of light 56, 58 may propagate from beam splitter/combiner 34 and enter second fiber coupling 40. In some embodiments, isolator 32 may be placed between beam splitter/combiner 34 and second fiber coupling 40. Second fiber coupling 40 may be a dual fiber coupling. Second fiber coupling 40 may be coupled to fibers 46, 48. Second fiber coupling may include at least one lens 42, which is used to focus each component of light 56, 58 into fibers 46, 48. In some embodiments, more than one set of fibers 46, 48 may be coupled to second fiber coupling 40. In such embodiments, each set of fibers 46, 48 may be coupled to second fiber coupling 40 and the components of light of each set of fibers may have properties as described herein for components of light 56, 58. At least one lens 42 may focus or collimate components of light 56, 58 entering or coming from fibers 46, 48. In some embodiments, at least one lens 42 may be a single lens that focuses each component of light 56, 58 into each respective fiber 46, 48. For example, lens 42 may focus component of light 56 into fiber 46 and component of light 58 into fiber 48, or vice versa. In other embodiments, a single lens may be used for each component of light. For example, a first lens focuses component of light 56 into fiber 46 while a second lens focuses component of light 58 into fiber 48.

At least one lens 42 may be a conventional spherical lens, a GRIN lens, an aspherical lens, or any combination thereof. In some embodiments, at least one lens 42 may collimate or focus components of light 56,58 entering the at least one lens. At least one lens 42 may be placed in an optimal position in relation to beam splitter/combiner 34 and fibers 46, 48. The optimal position may be a position such that spillover or transmission loss of light is minimized between beam splitter/combiner 34, at least one lens 42, and fibers 46, 48.

In an embodiment using a single lens as at least one lens 42, a diverging angle between two components of light 56, 58 propagating through the lens may be called a lens diverging angle. The lens diverging angle may substantially match the diverging angle, γ, of beam splitter/combiner 34. Matching of the lens diverging angle with the beam splitter/combiner diverging angle may minimize losses associated with combining components of light into a beam of light or splitting the beam of light into components.

Fibers 46, 48 may be single mode fibers, multimode fibers, or PM fibers. The first and second components of light 56, 58 may propagate along the length of fibers 46, 48. In some embodiments, fibers 46, 48 may be coupled in a pigtail configuration to improve the strength and flexibility of the fibers. A component beam of light may exit or enter fiber 46 through end 47. Similarly, a component beam of light may exit or enter fiber 48 through end 49. Ends 47, 49 may include optically polished surfaces. The optically polished surfaces may be angled to an optical axis of the fiber. In certain embodiments, an AR coating is applied to ends 47, 49 of fibers 46, 48, respectively.

In certain embodiments, fibers 46, 48 may be PM fibers. In such a case, fiber 46 may have an optical axis that is about 90° aligned relative to the optical axis of fiber 48. In addition, the optical axis of fiber 46 may be aligned with the optical axis of wedge 50 or, in some embodiments; the optical axis of fiber 46 may be perpendicular to the optical axis of wedge 50.

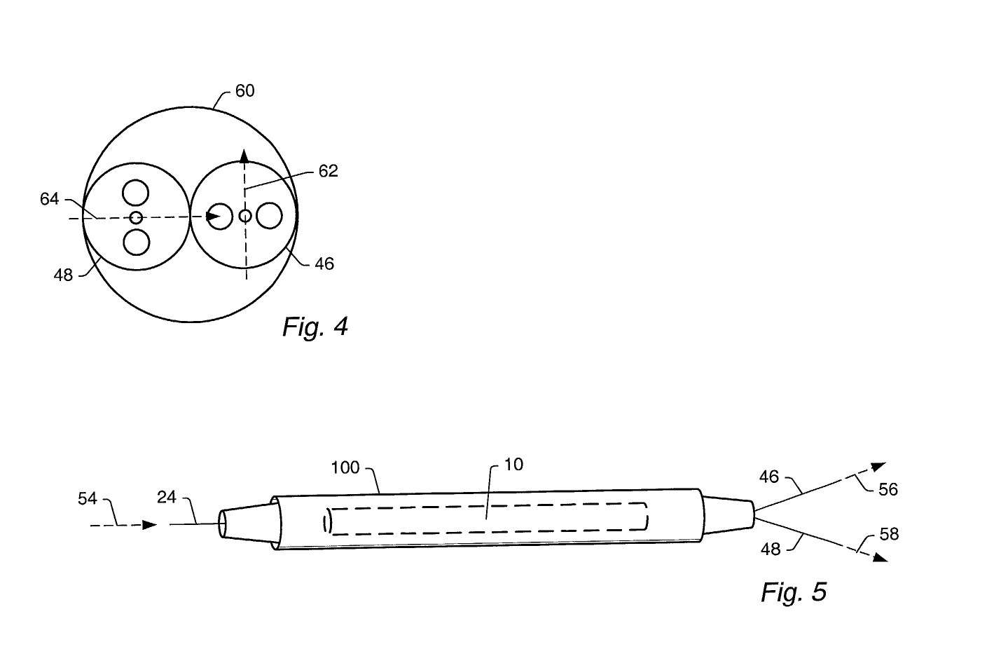

FIG. 4 depicts a cross-sectional view of an embodiment of ferrule 60 containing PM fibers 46, 48. Fiber 46 may have optical axis 62 that is about 90° aligned relative to optical axis 64 of fiber 48. Ferrule 60 may be terminated in an angle. The terminated angle of ferrule 60 may substantially coincide with angled ends 47, 49 of fibers 46, 48. In certain embodiments, an end of ferrule 60 is polished.

In an embodiment, beam splitter/combiner 34 is used to combine two components of light coming from second fiber coupling 40 into a combined beam of light. Components of light 56, 58 may enter the device through second fiber coupling 40 and be combined into a single beam of light 54 by beam splitter/combiner 34. In such a case, design parameters (e.g., diverging angle of beam splitter/combiner 34, lens positions, etc.) may be determined similarly as for the above embodiments that describe splitting a beam of light into two components of light. Optical beam splitting/combining device 10 may be used to operate as either a beam splitter or beam combiner depending on a desired use of the device. In certain embodiments, reversing the operation of optical beam splitting/combining device 10 may only require altering the path of light through isolator 32 as described above.

FIG. 5 depicts a schematic of an embodiment of optical beam splitting/combining device 10 placed in housing 100. Optical beam splitting/combining device 10 may include first fiber coupling 20, core section 30, and second fiber coupling 40 as described in the embodiment of FIG. 1. In an embodiment, optical beam splitting/combining device 10 may split beam of light 54, which enters the device through fiber 24, into first component of light 56 and second component of light 58, which exit the device through fibers 46, 48. In another embodiment, optical beam splitting/combining device 10 may combine first component of light 56 and second component of light 58, which enter the device through fibers 46, 48, into beam of light 54, which exits the device through fiber 24. Optical beam splitting/combining device 10 may also inhibit beams from traveling in a reverse direction (optical feedback) with the use of isolator 32.

In some embodiments, optical beam splitting/combining device 10 may be used as a passive device. The passive device may be a portion of an optical network. For example, optical beam splitting/combining device 10 may be used in Raman amplifiers (such as dual-band Raman amplifiers), erbium-doped fiber amplifiers (EDFAs), dense wavelength division multiplexing (DWDM) systems, or optical add/drop multiplexers. Because optical beam splitting/combining device 10 includes an optical path free of contaminants (e.g., epoxy or other bonding materials), the optical beam splitting/combining device may be operable at relatively high power densities (e.g., greater than about 500 milliwatts).

In an embodiment, optical beam splitting/combining device 10 may be used as a band splitter. For example, optical beam splitting/combining device 10 may be used as a C/L band splitter in an optical network. In another embodiment, optical beam splitting/combining device 10 may be used as a C/L band combiner in an optical network. Optical beam splitting/combining device 10 may provide excellent insertion loss behavior (i.e., low transmission losses), minimal polarization-dependent losses (PDL)(i.e., the difference in insertion loss for one polarization compared to another), and minimal polarization mode dispersion (PMD)(i.e., the difference in propagation speeds of different polarization planes).

Providing beam splitting/combining along with beam isolation in a single device may provide up to about 50% reduction in transmission losses as compared to using discrete splitting/combining devices and isolation devices. The increased transmission efficiency may also enable optical networks using optical beam splitting/combining device 10 to operate with lower power lasers, which tends to decrease costs (e.g., power costs or laser equipment costs) associated with installing and/or operating optical networks. Having the combined splitting/combining and isolation in a single device may also reduce the size of the optical device and/or reduce manufacturing costs of the device or optical network.

Optical beam splitting/combining device 10 may also have a relatively wide wavelength operating range (e.g., in the C and L bands). The relatively wide wavelength range of the optical beam splitting/combining device increases the usefulness of the device as the device may be used for a wide range of lasers. Since the optical beam splitting/combining device has the ability to be used for a wide range of lasers, the number of devices needed for a user's inventory tends to be reduced (e.g., one device may be used for multiple lasers rather than using several devices for multiple lasers).

It is to be understood that in any embodiment described herein, it may be possible to split multiple sets of beams of light and/or combine multiple sets of components of light using optical beam splitting/combining device 10. The multiple sets of beams of light and multiple sets of components of light may be multiplexed within optical beam splitting/combining device 10 such that the sets do not intersect or interfere with each other. It may also be necessary to modify optical beam splitting/combining device 10 such that the device can propagate multiple sets of beams or components. For example, lenses, fibers may be modified and/or additional lenses or fibers may be used to operate the optical beam splitting/combining device with multiple sets of beams or components.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. An optical device, comprising:
a first fiber coupling optically coupled to a fiber, wherein the fiber is configured to propagate a beam of light;
a beam splitter/combiner optically coupled to the first fiber coupling, wherein the beam splitter/combiner is configured to split the beam of light into a first component of light and a second component of light or to combine the first component of light and the second component of light into the beam of light;
an isolator optically coupled to the beam splitter/combiner; and
a second fiber coupling optically coupled to the isolator and optically coupled to a first additional fiber and a second additional fiber, wherein the first additional fiber is configured to propagate the first component of light and the second additional fiber is configured to propagate the second component of light.

2. The optical device of claim 1, wherein the first fiber coupling comprises at least one lens.

3. The optical device of claim 1, wherein the fiber comprises an end having an optically polished surface.

4. The optical device of claim 1, wherein the fiber comprises an end having an optically polished surface angled to an optical axis of the fiber.

5. The optical device of claim 1, wherein the fiber comprises an end having an AR coating.

6. The optical device of claim 1, wherein the first fiber coupling comprises at least one lens, and wherein the at least one lens is configured to collimate the beam of light propagating from the fiber or focus the beam of light propagating to the fiber.

7. The optical device of claim 1, wherein the beam splitter/combiner comprises a polarized beam splitter/combiner.

8. The optical device of claim 1, wherein the beam splitter/combiner comprises a prism.

9. The optical device of claim 1, wherein the beam splitter/combiner comprises two optical wedges.

10. The optical device of claim 1, wherein the beam splitter/combiner comprises two optical wedges, and wherein the optical axes of the two optical wedges are about 90° away from each other.

11. The optical device of claim 1, wherein the first and second components of light comprise substantially different polarization directions.

12. The optical device of claim 1, wherein the first and second components of light comprise substantially perpendicular polarization directions.

13. The optical device of claim 1, wherein the isolator comprises a Faraday isolator.

14. The optical device of claim 1, wherein the isolator is configured to inhibit optical feedback.

15. The optical device of claim 1, wherein the isolator is configured to inhibit optical feedback to either the first fiber coupling or the second fiber coupling depending on a use of the optical device.

16. The optical device of claim 1, wherein the isolator is configured to inhibit optical feedback to the first fiber coupling when the optical device is configured to be used as a beam splitter.

17. The optical device of claim 1, wherein the isolator is configured to inhibit optical feedback to the second fiber coupling when the optical device is configured to be used as a beam combiner.

18. The optical device of claim 1, wherein an isolation direction of the isolator is switched to inhibit optical feedback to either the first fiber coupling or the second fiber coupling.

19. The optical device of claim 1, wherein the isolator comprises a Faraday rotator, and wherein an isolation direction of the Faraday rotator can be switched mechanically.

20. The optical device of claim 1, wherein the isolator comprises a Faraday rotator, and wherein an isolation direction of the Faraday rotator can be switched electrically.

21. The optical device of claim 1, wherein the isolator is configured to provide about 30 dB optical isolation.

22. The optical device of claim 1, wherein the second fiber coupling is configured to focus the first and second components of light propagating into the first additional and second additional fibers, respectively, or to collimate the first and second components of light propagating from the first additional and second additional fibers, respectively.

23. The optical device of claim 1, wherein the second fiber coupling comprises a single lens.

24. The optical device of claim 1, wherein the second fiber coupling comprises at least one lens for each component of light.

25. The optical device of claim 1, wherein the first additional and second additional fibers comprise single mode fibers.

26. The optical device of claim 1, wherein the first additional and second additional fibers comprise multimode fibers.

27. The optical device of claim 1, wherein the first additional and second additional fibers comprise PM fibers.

28. The optical device of claim 1, wherein the first additional and second additional fibers comprise ends having optically polished surfaces.

29. The optical device of claim 1, wherein the first additional and second additional fibers comprise ends having optically polished surfaces angled to optical axes of the fibers.

30. The optical device of claim 1, wherein the first additional and second additional fibers comprise ends having AR coatings.

31. The optical device of claim 1, wherein the optical device is configured to be used as a beam splitter.

32. The optical device of claim 1, wherein the optical device is configured to be used as a beam combiner.

33. The optical device of claim 1, wherein the optical device is used as a passive device.

34. The optical device of claim 1, wherein the optical device is coupled to a laser.

35. The optical device of claim 1, wherein the optical device is used in an amplifier.

36. The optical device of claim 1, wherein the optical device is used in an optical network.

37. An optical beam splitting device, comprising:
a first fiber coupling optically coupled to a fiber, wherein the fiber is configured to propagate a beam of light;
a beam splitter optically coupled to the first fiber coupling, wherein the beam splitter is configured to split the beam of light into a first component of light and a second component of light;
an isolator optically coupled to the beam splitter; and
a second fiber coupling optically coupled to the isolator and optically coupled to a first additional fiber and a second additional fiber, wherein the first additional fiber is configured to propagate the first component of light and the second additional fiber is configured to propagate the second component of light.

38. The optical beam splitting device of claim 37, wherein the device can be used as a beam combiner.

39. The optical beam splitting device of claim 37, wherein an isolation direction of the isolator can be switched to use the device as a beam combiner.

40. An optical beam combining device, comprising:
a second fiber coupling optically coupled to a first fiber and a second fiber, wherein the first fiber is configured to propagate a first component of light and the second fiber is configured to propagate a second component of light;
a beam combiner optically coupled to the second fiber coupling, wherein the beam combiner is configured to combine the first component of light and the second component of light into a beam of light;
an isolator optically coupled to the beam combiner; and
a first fiber coupling optically coupled to the isolator and optically coupled to an additional fiber, wherein the additional fiber is configured to propagate the beam of light.

41. The optical beam combining device of claim 40, wherein the device can be used as a beam splitter.

42. The optical beam combining device of claim 40, wherein an isolation direction of the isolator can be switched to use the device as a beam splitter.

43. An optical device, comprising:
a first fiber coupling optically coupled to at least one fiber, wherein the at least one fiber is configured to propagate at least one beam of light;
a beam splitter/combiner optically coupled to the first fiber coupling, wherein the beam splitter/combiner is configured to split the at least one beam of light into at least two components of light or to combine the at least two components into the at least one beam of light;
an isolator optically coupled to the beam splitter/combiner; and
a second fiber coupling optically coupled to the isolator and optically coupled to at least two additional fibers, wherein each of the at least two additional fibers is configured to propagate at least one of the at least two components of light.

44. The optical device of claim 43, wherein the isolator is configured to inhibit optical feedback to either the first fiber coupling or the second fiber coupling depending on a use of the optical device.

45. The optical device of claim 43, wherein the isolator is configured to inhibit optical feedback to the first fiber coupling when the optical device is configured to be used as a beam splitter.

46. The optical device of claim 43, wherein the isolator is configured to inhibit optical feedback to the second fiber coupling when the optical device is configured to be used as a beam combiner.

47. The optical device of claim 43, wherein an isolation direction of the isolator is switched to inhibit optical feedback to either the first fiber coupling or the second fiber coupling.

48. An optical beam splitting device, comprising:
a first fiber coupling optically coupled to at least one fiber, wherein the at least one fiber is configured to propagate at least one beam of light;
a beam splitter optically coupled to the first fiber coupling, wherein the beam splitter is configured to split the at least one beam of light into at least two components of light;
an isolator optically coupled to the beam splitter; and
a second fiber coupling optically coupled to the isolator and optically coupled to at least two additional fibers, wherein each of the at least two additional fibers is configured to propagate at least one of the at least two components of light.

49. The optical beam splitting device of claim 48, wherein the device can be used as a beam combiner.

50. The optical beam splitting device of claim 48, wherein an isolation direction of the isolator can be switched to use the device as a beam combiner.

51. An optical beam combining device, comprising:
a second fiber coupling optically coupled to at least two fibers, wherein each of the at least two fibers is configured to propagate at least one of at least two components of light;
a beam combiner optically coupled to the second fiber coupling, wherein the beam combiner is configured to combine the at least two components of light into at least one beam of light;
an isolator optically coupled to the beam combiner; and
a first fiber coupling optically coupled to the isolator and optically coupled to at least one additional fiber, wherein the at least one additional fiber is configured to propagate the at least one beam of light.

52. The optical beam combining device of claim 51, wherein the device can be used as a beam splitter.

53. The optical beam combining device of claim 51, wherein an isolation direction of the isolator can be switched to use the device as a beam splitter.

54. A method for splitting a beam of light or combining two components of light with a single optical device, comprising:
propagating a beam of light through a fiber;
splitting the beam of light into a first component of light and a second component of light or combining the first component of light and the second component of light into the beam of light;
inhibiting optical feedback with an isolator;
propagating the first component of light through a first additional fiber; and
propagating the second component of light through a second additional fiber.

55. The method of claim 54, further comprising polarizing the first and second components of light such that the first component of light is polarized about 90° from the second component of light.

56. The method of claim 54, further comprising switching the isolator to inhibit optical feedback to either the fiber or the first additional fiber and the second additional fiber.

57. The method of claim 54, further comprising switching the isolator to inhibit optical feedback to the fiber when splitting the beam of light into the first component of light and the second component of light.

58. The method of claim 54, further comprising switching the isolator to inhibit optical feedback to the first additional fiber and the second additional fiber when combining the first component of light and the second component of light into the beam of light.

59. A method for splitting a beam of light, comprising:
propagating a beam of light through a fiber;
splitting the beam of light into a first component of light and a second component of light;
inhibiting optical feedback with an isolator;
propagating the first component of light through a first additional fiber; and
propagating the second component of light through a second additional fiber.

60. The method of claim 59, further comprising polarizing the first and second components of light such that the first component of light is polarized about 90° from the second component of light.

61. A method for combining components of light, comprising:
propagating a first component of light through a first fiber;
propagating a second component of light through a second fiber;
combining the first component of light and the second component of light into a combined beam of light;
inhibiting optical feedback with an isolator; and
propagating the combined beam of light through an additional fiber.

62. The method of claim 61, wherein the first component of light is polarized about 90° from the second component of light.
